(19) United States
(12) Patent Application Publication
(10) Pub. No.: US 2026/0229019 A1
(43) Pub. Date: Aug. 6, 2026

(54) NEURAL VIDEO CODING

(71) Applicant: Microsoft Technology Licensing, LLC, Redmond, WA (US)

(72) Inventors: Jiahao LI, Beijing (CN); Bin LI, Beijing (CN); Yan LU, Beijing (CN)

(73) Assignee: Microsoft Technology Licensing, LLC, Redmond, WA (US)

(21) Appl. No.: 19/142,265

(22) PCT Filed: Dec. 18, 2023
(86) PCT No.: PCT/US2023/084484

§ 371 Date: Jun. 23, 2025

(30) Foreign Application Priority Data
Jan. 20, 2023 (CN) 202310098152.9

(51) Int. Cl. G06V 10/70; G06F 18/213; G06V 10/62; G06V 10/77; G06V 10/82; G06V 20/40; H04N 19/13; H04N 19/137; H04N 19/172; H04N 19/196

(52) U.S. Cl. CPC G06V 10/768; G06F 18/213; G06V 10/62; G06V 10/7715; G06V 20/46; H04N 19/13; H04N 19/137; H04N 19/172; H04N 19/196; G06V 10/82

(57) ABSTRACT

According to implementations of the subject matter described herein, a solution for neural video coding is provided. According to the solution, estimated motion information of a target frame in a video, reference feature information and a reference reconstructed frame of a reference frame for the target frame are obtained. Context information for the target frame is determined using a context extraction model and based on the estimated motion information, the reference reconstructed frame, and the reference feature information. In a conversion between the target frame and a bitstream of the video, a reconstructed target frame of the target frame is generated using a frame coding model and based on at least the context information. In this way, richer context information can be extracted for coding and thus the coding efficiency can be improved.

### BACKGROUND

The main principle of video codec is that, for the current frame to be coded, the codec will find the relevant context information (e.g., various predictions as context information) from previously reconstructed frames to reduce the spatial-temporal redundancy. The more relevant the context information is, the higher bitrate saving is achieved. Traditional video coding (e.g., from H.261 to H.266) extracts and utilizes context information from various hand-crafted coding modes. At present, neural video codec (NVC) is proposed for extraction and utilization of context information in an automatic-learned manner, which will bring more flexibility and improve coding efficiency.

### SUMMARY

According to implementations of the subject matter described herein, a solution for neural video coding is proposed. In this solution, estimated motion information of a target frame in a video, reference feature information and a reference reconstructed frame of a reference frame for the target frame are obtained. Context information for the target frame is determined using a context extraction model and based on the estimated motion information, the reference reconstructed frame, and the reference feature information. In a conversion between the target frame and a bitstream of the video, a reconstructed target frame of the target frame is generated using a frame coding model and based on at least the context information. In this way, richer context information can be extracted for coding and thus the coding efficiency can be improved.

The Summary is provided to introduce a selection of concepts in a simplified form that are further described below in the Detailed Description. The Summary is neither intended to identify key features or essential features of the subject matter described herein, nor is it intended to be used to limit the scope of the subject matter described herein.

### BRIEF DESCRIPTION OF THE DRAWINGS

FIG. 1 illustrates a block diagram of an example environment in which various implementations of the subject matter described herein can be implemented;

FIG. 2 illustrates a schematic block diagram of a neural video codec system in accordance with some implementations of the subject matter described herein;

FIG. 3 illustrates a schematic block diagram of example architecture of a context extraction model in accordance with some implementations of the subject matter described herein;

FIG. 4 illustrates a schematic block diagram of example architecture of an offset predictor in the context extraction model in accordance with some implementations of the subject matter described herein;

FIG. 5 illustrates a schematic block diagram of example architecture of a cross-group aggregator in the context extraction model in accordance with some implementations of the subject matter described herein;

FIG. 6 illustrates a schematic block diagram of example architecture of a frame coding model in accordance with some implementations of the subject matter described herein;

FIG. 7 illustrates a schematic block diagram of an example model implementation of the frame coding model in accordance with some implementations of the subject matter described herein;

FIG. 8 illustrates an example flow of group-based entropy coding operations in accordance with some implementations of the subject matter described herein;

FIG. 9 illustrates a schematic block diagram of an example model implementation of an entropy coding network in accordance with some implementations of the subject matter described herein;

FIG. 10 illustrates a schematic block diagram of an example model implementation of a deep convolution block in the entropy coding network in accordance with some implementations of the subject matter described herein;

FIG. 11 illustrates a comparison between a hierarchical quality structure of frames in accordance with some implantations of the subject matter described herein and the hierarchical quality structure of a traditional codec;

FIG. 12 illustrates a flowchart of a process for video processing in accordance with some implementations of the subject matter described herein; and

FIG. 13 illustrates a schematic block diagram of an electronic device in which various implementations of the subject matter described herein can be implemented.

Throughout the drawings, the same or similar reference symbols refer to the same or similar elements.

### DETAILED DESCRIPTION OF EMBODIMENTS

The subject matter described herein will now be described with reference to some example implementations. It is to be understood that these implementations are described only for the purpose of illustration and help those skilled in the art to better understand and thus implement the subject matter described herein, without suggesting any limitations to the scope of the subject matter described herein.

As used herein, the term “includes” and its variants are to be read as open terms that mean “includes but is not limited to.” The term “based on” is to be read as “based at least in part on.” The terms “an implementation” and “one implementation” are to be read as “at least one implementation.” The term “another implementation” is to be read as “at least one other implementation.” The term “first,” “second,” and the like may refer to different or the same objects.

Other definitions, either explicit or implicit, may be included below.

As used herein, the term “model” may learn an association between corresponding input and output from training data, and thus a corresponding output may be generated for a given input after the training. The generation of the model may be based on machine learning techniques. Deep learning (DL) is one of machine learning algorithms that processes the input and provides the corresponding output using a plurality of layers of processing units. A neural network model is an example of a deep learning-based model. As used herein, “model” may also be referred to as “machine learning model”, “learning model”, “machine learning network” or “learning network”, which are used interchangeably herein.

Generally, machine learning may roughly include three stages, i.e., a training stage, a test stage, and an application stage (also referred to as an interference stage). In the training stage, a given model may be trained using a large scale of training data, with parameter values being iteratively updated until the model can obtain, from the training data, consistent interference that meets an expected target. Through the training, the model may be considered as being capable of learning the association between the input and the output (also referred to as an input-to-output mapping) from the training data. The parameter values of the trained model are determined. In the test stage, test inputs are applied to the trained model to test whether the model can provide correct outputs, so as to determine the performance of the model. In the interference stage, the model may be utilized to process a practical input based on the parameter values obtained from the training and to determine the corresponding output.

### Example Environment

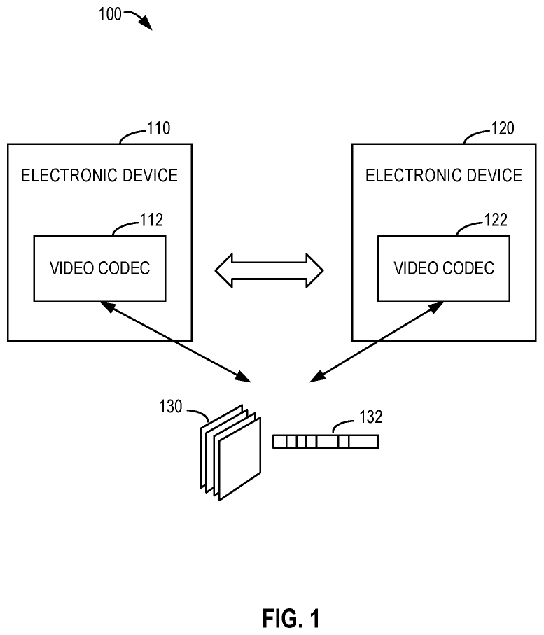

FIG. 1 illustrates a block diagram of an example environment 100 in which various implementations of the subject matter described herein can be implemented. In the environment of FIG. 1, an electronic device 110 includes a video codec 112 configured to encode and/or decode a video. An electronic device 120 includes a video codec 122 configured to encode and/or decode a video. The video codec 112 or 122 may include encoders and/or decoders. During the encoding, an encoder may encode a video 130 into a bitstream 132. During the decoding, a decoder may decode the bitstream 132 into the video 130.

The electronic devices 110 and 120 can communicate with each other through any appropriate communication network. In some codec scenarios, the electronic device 110 and the electronic device 120 may perform video communication, and the video codec 112 and 122 may both implement the encoding and decoding of the video. For example, the electronic device 110 may provide a bitstream obtained after video encoding to the electronic device 120 for decoding, and the electronic device 120 may decode the received bitstream to obtain the corresponding video. In addition, the electronic device 120 may also provide a video encoding result to the electronic device 110 for decoding. In some codec scenarios, the video codec 112 in the electronic device 110 may include an encoder for encoding a video into a bitstream. The electronic device 120 may include a video playback tool, where the video codec 122 includes a decoder for decoding the bitstream generated by the video codec 112 to obtain the video for playback.

It would be appreciated that the devices and elements shown in FIG. 1 are only examples. In practical applications, there may exist more electronic devices, and each electronic device may have video encoding and/or decoding functions.

In traditional video coding (e.g., from H.261 to H.266), the coding gain mainly comes from the continuously expanded coding modes, where each mode uses a specially designed manner to extract and utilize context information. For example, the numbers of intra prediction directions used in H.266 is up to 65. So many modes can extract diverse context information to reduce redundancy, but also bring huge complexity as rate distortion optimization (RDO) is used to search the best mode. For coding of a frame with a resolution of 1080p, the under-developing traditional video codec may take up to half an hour.

By contrast, neural video codec (NVC) has changed the way of context extraction and utilization from hand-crafted design to automatic-learned manner. Neural video codec can be classified into residual coding-based and condition coding-based. The residual coding directly uses the reconstructed frame as the context, and the context utilization is restricted to use subtraction for redundancy removal. The condition coding explicitly learns feature domain contexts. The high-dimensional contexts can carry richer information to facilitates encoding, decoding, as well as entropy modelling.

However, for most NVCs, the manners of context extraction and utilization are still limited, and only a single optical flow is used to explore temporal correlation. This makes NVC easily suffer from uncertainty in parameters or fall into local optimum. One solution is to add traditional codec-like coding modes into NVC, but this will bring large computational complexity. Therefore, it is expected to learn and use context information better in NVC, while yielding low computational cost.

### System Architecture of Video Coding

In the example implementations of the subject matter described herein, an improved solution for neural video coding is proposed. In this solution, for a target frame to be coded, context information for the target frame is determined based on estimated motion information of the target frame, a reference reconstructed frame and reference feature information for a reference frame. The extracted context information is used to generate a target reconstructed frame of the target frame, which is used in a conversion between the target frame and a bitstream of the video. During the neural video coding, both the feature information in the feature domain and the reference reconstructed frame in the non-feature domain are used to extract the contexts of the target frame. In this way, the diversity of context information can be increased, which in turn can improve the coding and compression efficiency.

Some example implementations of the subject matter described herein will be described in more detail below with reference to the accompanying drawings.

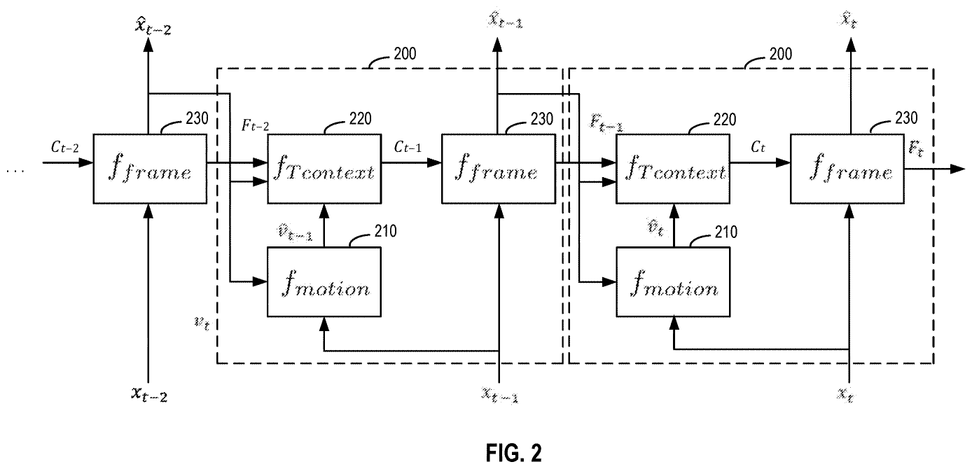

FIG. 2 illustrates a schematic block diagram of a neural video codec system 200 in accordance with some implementations of the subject matter described herein. The respective components in the neural video codec system 200 may be implemented in hardware, software, firmware or any combination thereof. The neural video codec system 200 may be implemented in the video codec 112 and/or 122 of FIG. 1.

The neural video codec system 200 generally includes a motion estimation model 210, a context extraction model 220, and a frame coding model 230. Those models may be implemented based on the machine learning techniques, for example, the neural network architecture. To obtain a higher compression ratio, the neural video codec system 200 is implemented based on condition coding, which is more flexible and can guide the coding of frames under the condition of the extracted context information.

The neural video codec system 200 can implement a conversion between each frame in a video and a bitstream of the video. The conversion includes an encoding process of the video, a decoding process of the video, or both. During the encoding process, the neural video codec system 200 receives a sequence of frames of the video, and can perform video coding on respective frames to obtain the bitstream of the video. In the decoding process, the neural video codec system 200 receives the bitstream of the video and decodes therefrom the sequence of frames of the video. In the following, except for the operations that are explicitly specified, other operations may be considered to be performed at both the encoding and decoding sides of the video.

In this paper, a target frame xₜ refers to the current frame to be coded in the video. As shown in FIG. 2, to encode and decode the target frame xₜ with an index t, the motion estimation model 210 is configured to determine motion information vₜ of the target frame xₜ, encode the motion information vₜ and then decode it as estimated motion information \hat{v}ₜ. The above operations are performed at the encoding side of the video. At the decoding side of the video, the encoded motion information vₜ may be transmitted to the decoding side for decoding the estimated motion information \hat{v}ₜ. The processing of the motion estimation model 210 is represented as fₘₒₜᵢₒₙ.

The motion information indicates motion offsets of elements in the target frame xₜ relative to a reference frame, including the offset sizes and directions. For example, the motion information may include a motion vector (MV). The reference frame may also be used as an input for the motion estimation of the target frame xₜ. In some implementations, the reference frame of the target frame xₜ may be one or more previous frames of the target frame xₜ. In the following implementations, only a single reference frame is taken as an example for illustration, although a plurality of reference frames are also feasible. As shown in FIG. 2, a previous frame xₜ₋₁ before the target frame xₜ is used as the reference frame. In some implementations, the motion estimation model 210 may be configured to determine the estimated motion information \hat{v}ₜ based on an optical flow network. In addition to the optical flow network, the motion estimation model 210 may also be implemented based on any other appropriate models that can determine the motion information of the frame.

The context extraction model 220 is configured to determine context information Cₜ for the target frame xₜ. In the implementations of the subject matter described herein, the context extraction model 220 is configured to determine the context information Cₜ for the target frame xₜ based on the estimated motion information \hat{v}ₜ of the target frame xₜ and the relevant information of the reference frame (the frame xₜ₋₁). The used relevant information of the reference frame includes reference feature information Fₜ₋₁ and a reference reconstructed frame \hat{x}ₜ₋₁ for the reference frame xₜ₋₁. The reference feature information Fₜ₋₁ of the reference frame xₜ₋₁ may characterize feature parameter representations of the reference frame in the feature space of the reference frame. The reference reconstructed frame \hat{x}ₜ₋₁ is the reconstruction result for the reference frame xₜ₋₁. During the encoding and decoding, the respective frames will be reconstructed. The reference feature information Fₜ₋₁ and the reference reconstructed frame \hat{x}ₜ₋₁ can complement each other to provide richer and more relevant context information of the target frame xₜ. Such context information is also referred to spatial context information. The richer and more relevant context information can effectively reduce the temporal redundancy of video frames and improve the coding and compression efficiency. Moreover, on the basis of the estimated motion information \hat{v}ₜ of the target frame xₜ, the context extraction model 220 can extract motion-aligned context information Cₜ. The processing of the context extraction model 220 is represented as f_{Tcontext}.

The frame coding model 230 is configured to generate a target reconstructed frame \hat{x}ₜ of the target frame xₜ based on at least the context information Cₜ. In addition, the frame coding model 230 is further configured to generate target feature information Fₜ of the target frame based on at least the context information Cₜ. The target feature information Fₜ and the target reconstructed frame \hat{x}ₜ are buffered and transferred for coding of a next frame until the coding of the whole video is completed. At the decoding side, the target reconstructed frame \hat{x}ₜ may be output as the decoding target.

At the encoding side, conditioned on the context information Cₜ, the frame coding model 230 may encode the target frame xₜ into a quantized code representation ŷₜ. At the decoding side, the quantized code representation ŷₜ may be determined from the bitstream of the video. After entropy-coding on the quantized code representation ŷₜ, the target reconstructed frame \hat{x}ₜ and the target feature information Fₜ are reconstructed based on the entropy coding result. The processing of the frame coding model 230 is represented as f_{frame}.

FIG. 2 illustrates the coding pipeline for respective frames xₜ₋₂, xₜ₋₁, xₜ and so on by the neural video codec system 20. For each frame, the motion estimation model 210, the context extraction model 220, and the frame coding model 230 in the system 200 perform the similar operations.

The overall workflow of the neural video codec system 200 is described above. Example implementations of the context extraction and the frame coding will be discussed in more detail below.

### Example Implementations of Context Extraction

In some implementations, offset diversity is applied to strength the extraction of context information in the context extraction process. A plurality of motion offsets can reduce the motion errors for complex motions or large movement. Diverse offsets can complement each other, giving an opportunity to provide better temporal reference to reduce redundancy and improve coding efficiency. In some implementations, a plurality of motion offsets may also be partitioned into groups, and cross-group fusion may be performed to bring to benefits to the mining of temporal context information.

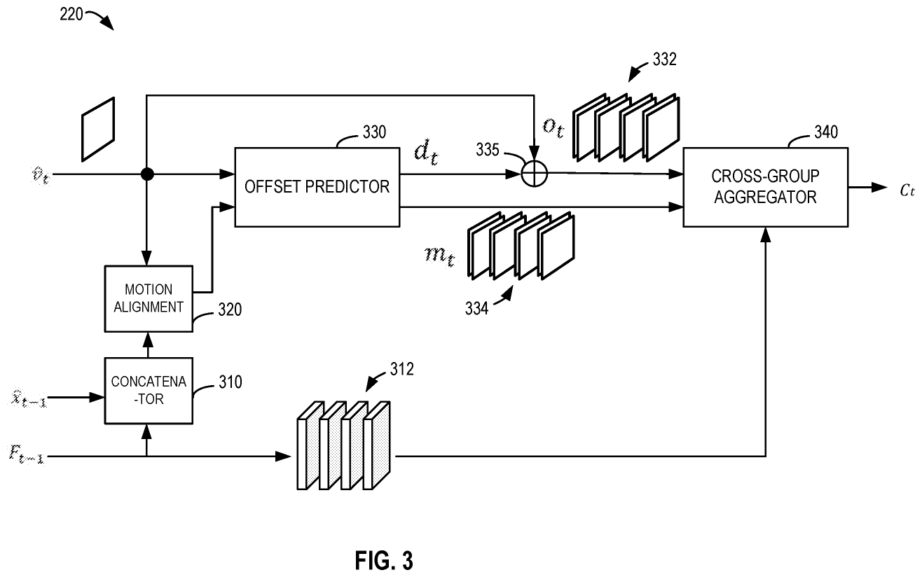

FIG. 3 illustrates a schematic block diagram of example architecture of the context extraction model 220 in accordance with some implementations of the subject matter described herein. As shown in FIG. 3, the context extraction model 220 includes a concatenator 310, a motion alignment unit 320, an offset predictor 330, an adder 335, and a cross-group aggregator 340.

Due to the various motions between frames, directly using the unprocessed reference feature information Fₜ₋₁ without motion alignment is hard to determine temporal correspondence in the coding process. Therefore, the motion estimation model 210 is also used to extract motion information in neural video coding, to extract motion-aligned context information Cₜ in the context extraction. The input of the context extraction model 220 includes the estimated motion information \hat{v}ₜ of the target frame, the reference feature information Fₜ₋₁ and the reference reconstructed frame \hat{x}ₜ₋₁ of the reference frame xₜ₋₁. The context extraction process is represented as f_{Tcontext}([Fₜ₋₁, \hat{x}ₜ₋₁], \hat{v}ₜ).

Most existing NVCs directly perform the motion alignment operation on a single MV in the estimated motion information. Such single motion-based alignment is not robust to complex motions or occlusions. In some implementations of the subject matter described herein, the offset predictor 330 is configured to determine residual offsets dₜ based on the estimated motion information \hat{v}ₜ, the reference feature information Fₜ₋₁ and the reference reconstructed frame \hat{x}ₜ₋₁ of the reference frame xₜ₋₁, where the reference feature information Fₜ₋₁ and the reference reconstructed frame \hat{x}ₜ₋₁ are used as auxiliary information to assist in determining the residual offsets dₜ. The reference feature information Fₜ₋₁ and the reference reconstructed frame \hat{x}ₜ₋₁ may be first concatenated by the concatenator 310. The concatenated [Fₜ₋₁, \hat{x}ₜ₋₁] and the estimated motion information \hat{v}ₜ are motion-aligned to the target frame xₜ by the motion alignment unit 320. The motion-aligned [Fₜ₋₁, \hat{x}ₜ₋₁] and motion-aligned \hat{v}ₜ are fed to the offset predictor 330 together with the unaligned \hat{v}ₜ for determining the residual offsets dₜ. The adder 335 can add the residual offsets dₜ to the estimated motion information \hat{v}ₜ (which is used as the base motion information) to obtain motion offsets oₜ 332 from the reference frame to the target frame. In some implementations, a plurality of motion offsets from the reference frame xₜ₋₁ to the target frame xₜ may be determined. When determining the offsets, the reference feature information Fₜ₋₁ may be partitioned into a plurality of groups. The reference feature information Fₜ₋₁ may be represented in form of feature maps, including a plurality of reference feature maps along a channel dimension. For example, the dimensions of the reference feature information Fₜ₋₁ may be C×W×H, where C represents the number of channels in the channel dimension, W and H represent two spatial dimensions, i.e., the width and height of a feature map. A plurality of reference feature maps in the reference feature information Fₜ₋₁ may be partitioned into a first number (represented as G) of feature map groups 312, where G is greater than or equal to 1. For example, a plurality of reference feature maps may be partitioned into G feature map groups along the channel dimension. For each feature map group, a second number of motion offsets (expressed as N) may be determined based on the estimated motion information \hat{v}ₜ, the reference reconstructed frame \hat{x}ₜ₋₁ and the feature map group, where N is greater than 1. In this way, the offset predictor 330 may determine G×N residual offsets, which are added to the estimated motion information \hat{v}ₜ to generate G×N motion offsets oₜ 332.

The values of G and N may be configured according to the practical requirements in applications. In some implementations, in addition to grouping the reference feature information Fₜ₋₁ along the channel dimension, the reference feature information Fₜ₋₁ may also be grouped along one or two spatial dimensions, and a plurality of motion offsets are determined for each group to increase the offset diversity. The plurality of determined motion offsets can complement each other. The diversity of motion offsets can facilitate the codec to deal with complex motions and occlusion of objects.

The G×N motion offsets oₜ 332 are provided to the cross-group aggregator 340 to determine the context information Cₜ of the target frame xₜ. In some implementations, in addition to the residual offsets dₜ, the offset predictor 330 may also generate weights mₜ 334 for the motion offsets 332, which is considered to reflect the confidence of each motion offset. The weights mₜ 334 and the motion offsets oₜ 332 are used together to determine the context information Cₜ.

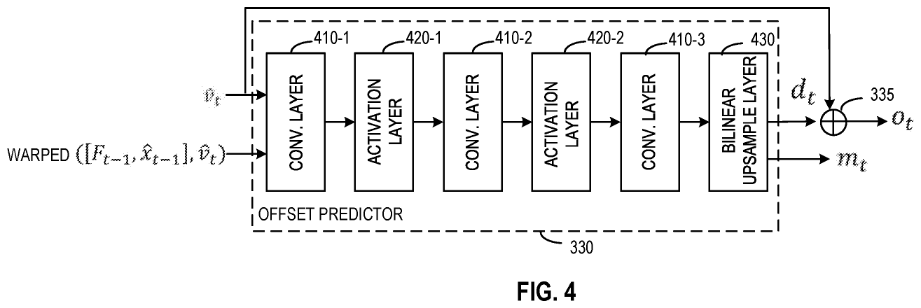

FIG. 4 illustrates a schematic block diagram of example architecture of the offset predictor 330 in the context extraction model 220 in accordance with some implementations of the subject matter described herein. As shown in FIG. 4, the offset predictor 330 may be based on a convolutional neural network, including a plurality of convolution layers 410-1, 410-2, and 410-3. An activation layer may be deployed between the two convolution layers, including, for example, activation layers 420-1 and 420-2. The convolution kernel size, input channel number, output channel number and step size of the respective convolution layers may be configured according to practical requirements. The activation layers may be, for example, based on the leaky ReLU function or any other appropriate activation functions.

In some implementations, to accelerate calculation, the resolution of the input may be reduced by two or more times in the first layer or layers of the offset predictor 330. In such implementations, the offset predictor 330 may also include a bilinear upsample layer 430 to upsample the output to the resolution corresponding to the input.

The input of the offset predictor 330 includes the motion-aligned [Fₜ₋₁, \hat{x}ₜ₋₁, \hat{v}ₜ] and the estimated motion information \hat{v}ₜ, and the output of the offset predictor 330 includes G×N residual offsets dₜ and the weights mₜ334 for respective motion offsets. G×N residual offsets dₜ are added to the estimated motion information \hat{v}ₜ, to obtain G×N motion offsets oₜ 332.

It would be appreciated that FIG. 4 illustrates the example model architecture implementation of the offset predictor 330. Depending on the practical application needs, other model architecture can also be applied to implement the offset predictor 330.

The G×N motion offsets of 332 may be used to perform motion alignment on the reference feature information Fₜ₋₁ to align the reference feature information Fₜ₋₁ to the space of the target frame. The motion-aligned reference feature information Fₜ₋₁ is used to determine the context information Cₜ for the target frame xₜ. In some implementations, for each feature map group in the G feature map groups 312, N motion offsets oₜ determined for this feature map group are used respectively to perform N times of motion alignment on this feature map group, to obtain N aligned feature map groups. The G×N aligned feature map groups determined for the G feature map groups may be aggregated to determine the context information Cₜ.

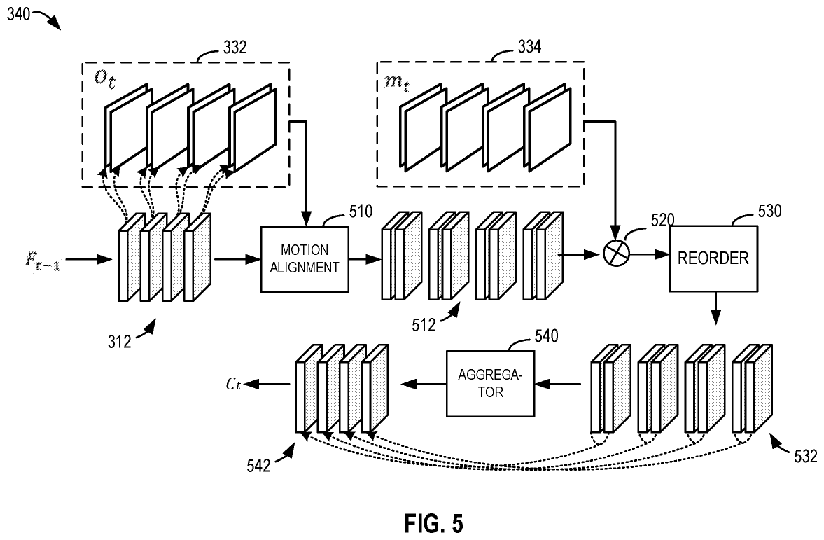

FIG. 5 illustrates a schematic block diagram of example architecture of the cross-group aggregator 340 in the context extraction model 220 in accordance with some implementations of the subject matter described herein. As shown in FIG. 5, the cross-group aggregator 340 includes a motion alignment unit 510, a weighting component 520, a reorder 530, and an aggregator 540.

The motion alignment unit 510 is configured to, for each feature map group of the G feature map groups 312, perform the motion alignment on the feature map group using the N motion offsets oₜ 332 determined for this feature map group, to obtain G×N aligned feature map groups 512. In some implementations, the weighting component 520 is configured to use the weights mₜ 334 for respective motion offsets to weight the G×N aligned feature map groups 512. The weighted G×N aligned feature map groups are provided to the reorder 530.

In some implementations, during the aggregating of the aligned feature map groups, it is proposed cross-feature map group merging, where each merged feature map group is merged from different aligned feature map groups. Thus, the G×N aligned feature map groups 512 may be merged to obtain G merged feature map groups. Specifically, after the motion alignment is performed on each feature map group with the plurality of motion offsets and the corresponding weights are weighted, the aligned feature map groups may be reordered by the reorder 530 before the aggregation.

Assuming that an aligned feature map group

$${g}_{i}^{j}$$

represents the 1-th aligned feature map group after motion alignment by the j-th motion offset, the weighted G×N aligned feature map groups before the reordering are

$${g}_{0}^{0} , … , {g}_{0}^{N - 1} , {g}_{1}^{0} , … , {g}_{1}^{N - 1} , … , {g}_{G - 1}^{0} , … , {g}_{G - 1}^{N - 1} ,$$

where the motion offset order is primary and the group order is secondary. The reorder 530 may reorder the above G×N aligned feature map groups as

$${g}_{0}^{0} , … , {g}_{G - 1}^{0} , {g}_{1}^{0} , … , {g}_{1}^{1} , … , {g}_{0}^{N - 1} , … , {g}_{G - 1}^{N - 1} ,$$

where the group order is primary and the motion offset order is secondary. For the reordered G×N aligned feature map groups 532, the aggregator 540 may merge each N consecutive aligned feature maps into a merged feature map group and then G merged feature map groups 542 are obtained. In this way, a merged feature map group may contain feature information that are motion aligned based on the motion offsets determined for different feature map groups.

Therefore, during this process, the group reordering enables more cross-group interactions without increasing computational complexity. Such aggregation can also enjoy the similar benefits with the weighted prediction from different reference frames in traditional codec. Via the cross-group fusion, more diverse combinations in extracting temporal contexts from different feature map groups may be introduced and further improve the effectiveness of offset diversity.

In some implementations, the G merged feature map groups 542 may be determined as context information Cₜ. In some implementations, other transformations may be applied on the G merged feature map groups 542 to obtain the context information Cₜ.

Compared with the solutions in the traditional codec where more coding modes are introduced to implement the context information extraction, the context information extraction proposed in the implementations of the subject matter described herein can extract and utilize high-quality temporal context information, without introducing additional model reference cost.

### Example Implementations of Frame Coding

In some implementations, in addition to increasing the temporal context diversity in the context extraction model, a manner to increase spatial context diversity is also proposed when encoding the frame into a quantized code representation (also known as latent representation) during the frame coding. The prediction of statistical information (such as distribution information) is improved by group-based entropy coding. Compared with conventional entropy coding methods, the group-based entropy coding can achieve more diverse correlation modeling, so the model has more opportunities to find more relevant spatial context information.

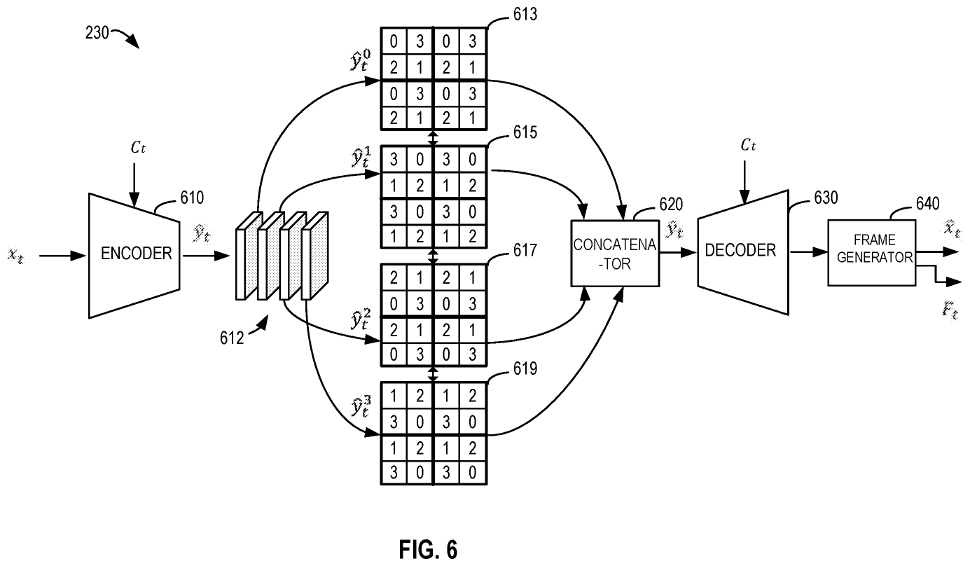

FIG. 6 illustrates a schematic block diagram of example architecture of the frame coding model 230 in accordance with some implementations of the subject matter described herein. As shown in FIG. 6, the frame coding model 230 may include an encoder 610, a concatenator 620, a decoder 630, and a frame generator 640. At the video decoding side, the encoder 610 may be omitted. The encoder 610 is configured to encode the target frame xₜ into a quantized code representation ŷₜ conditioned on the above information Cₜ. Then, statistical information of the quantized code representation ŷₜ is estimated, such as the probability density function (PMF), probability distribution function, mean, standard deviation, variance, scale value, and so on. The estimation of the statistical information is usually performed via an entropy coding model. In addition, the entropy coding model also generates a plurality of quantization step (QS) parameters. The output of the entropy coding model is used to assist the encoding of the encoder 610 and the subsequent decoding of the decoder 630.

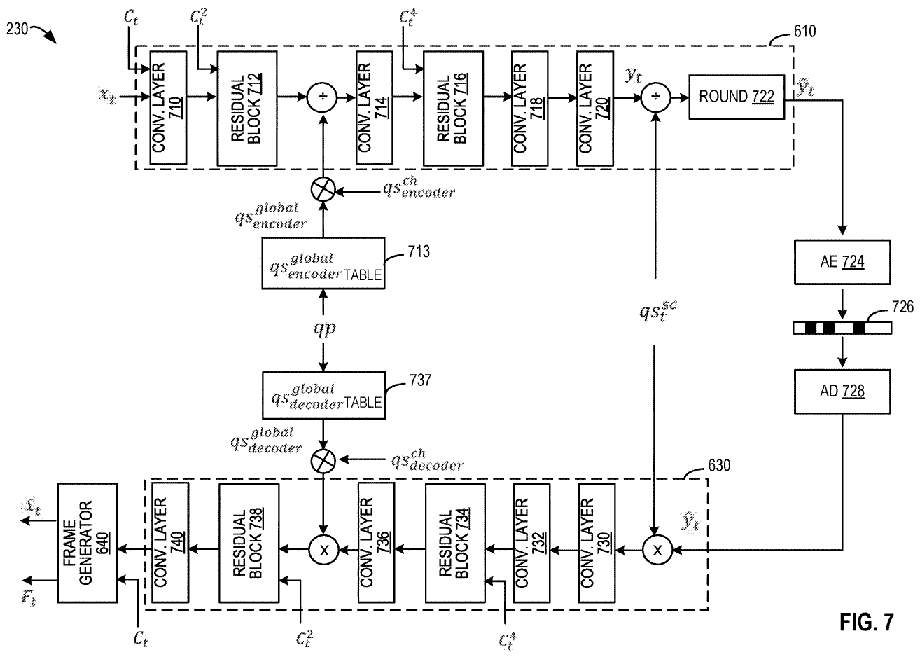

The decoder 630 is configured to decode the quantized code representation ŷₜ conditioned on the above information Cₜ. The decoding result is provided to the frame generator 640, which generates the target reconstructed frame \hat{x}ₜ and target feature information Fₜ for the target frame. FIG. 7 illustrates a schematic block diagram of an example model implementation of the frame coding model 230 in accordance with some implementations of the subject matter described herein. In the example of FIG. 7, the encoder 610 and the decoder 630 in the frame coding model 230 may be implemented based on convolution layers. As shown in FIG. 7, the encoder 610 includes one or more convolution layers and residual layers, including sequentially connected convolution layer 710, residual block 712, convolution layer 714, residual block 716, and convolution layers 718 and 720. Similarly, the decoder 630 also includes sequentially connected convolution layers 730 and 732, residual block 734, convolution layer 736, residual block 738, and convolution layer 740. In some implementations, the encoder 610 and/or the decoder 630 may be set to apply unequal channel numbers in order to accelerate the processing and reduce the computational cost. Specifically, different channel numbers are set for features with different resolutions, where the features with higher resolutions are set with fewer channels.

As shown in FIG. 7, in the encoder 610, the convolution layer 710 and the residual block 712 process the target frame xₜ and the context information Cₜ. The convolution layer 710 with the high-resolution context information Cₜ as its input may be configured to have a smaller number of channels. At the decoding side, the frame generator 640 with the high-resolution context information Cₜ as its input and also with the high-resolution target feature information Fₜ as its output may also be configured to have a fewer channels. In some implementations, the quantized code representation ŷₜ output by the encoder 610 may have a larger number of channels, which can bring compression ratio improvements as the quantized code representation can have larger capacity. By adjusting the number of channels in different processing layers during the encoding and decoding process, a better trade-off between compression ratio and computational overhead can be achieved. In some implementations, the downsampled context information is also introduced in some processing layers, for example, the context information after two-times and four-times downsampling may be input into the residual blocks 712 and 716 in the encoder 610, respectively, and input into the residual blocks 738 and 734 in the decoder 630, respectively. In some implementations, for more precise bitrate adjustment, some quantization operations may be moved to a higher resolution. As shown in FIG. 7, the quantization parameter qp may be used for controlling the bitrate via the user input. According to the quantization parameter qp, the global quantization step

$$q {s}_{e n c o d e r}^{g l o b a l}$$

is queried via a learnable quantization parameter-to-quantization step table, i.e., the

$$q {s}_{e n c o d e r}^{g l o b a l}$$

table 713. Ine learnable channel-wise quantization step

$$q {s}_{e n c o d e r}^{c h}$$

is used to modulate the quantization step for each channel. The quantization steps

$${qs}_{e n c o d e r}^{g l o b a l} and {qs}_{e n c o d e r}^{c h}$$

are used to quantize a code representation output by the residual block 712, and the quantization result is further provided to the next processing layer, namely, the convolution layer 714 for processing. In some implementations, before the round operation 722, the spatial-channel-wise quantization step

$$q {s}_{t}^{s c}$$

is applied to the quantized code representation yₜ of the target frame, where the quantization step

$$q {s}_{t}^{s c}$$

is generated for the target frame xₜ by the entropy coding model. During the decoding, the inverse operations to those of the encoder 610 are performed in the decoder 640. In the decoding, according to the quantization parameter qp, the global quantization step

$$q {s}_{d e c o d e r}^{g l o b a l}$$

is queried via a learnable quantization parameter-to-quantization step table, i.e., the

$$q {s}_{d e c o d e r}^{g l o b a l}$$

table 737. The learnable channel-wise quantization step

$$q {s}_{d e c o d e r}^{c h}$$

is used to modulate the quantization step for each channel. The quantization steps

$$q {s}_{d e c o d e r}^{g l o b a l} and {qs}_{d e c o d e r}^{c h}$$

are used for quantization at a processing layer with a higher resolution (for example, with a lower number of channels), such as for quantizing a code representation output by the convolution layer 736, in order to achieve finer-grained adjustment. The spatial-channel-wise quantization step

$$q {s}_{t}^{s c}$$

output by the entropy coding model is applied to quantize the quantized code representation ŷₜ.

In some implementations, separate learnable quantization parameter-to-quantization step tables are applied by the encoder and the decoder in the frame coding model 230, which can enlarge the flexibility.

In the frame coding model 230, the quantized code representation after the quantization and rounding may be provided to the arithmetic encoder (AE) 724. The AE 724 generates a bitstream 726 of the video. The bitstream 726 is decoded by the arithmetic decoder (AD) 728 to obtain the quantized code representation ŷₜ. At the decoding device side of the video, the AE 724 may not be needed, and the decoding device may start with the received bitstream 726 and provide the quantized code representation ŷₜ decoded by the AD to the decoder 640.

Some specific implementations of the frame coding model 230 are discussed above. It would be appreciated that FIG. 7 only illustrates an example model structure of the frame coding model 230. In practical applications, other model structures may be configured for the frame coding model 230 if required.

As mentioned above, the entropy coding model is needed in the frame coding process to determine the statistical information and the quantization step of the quantized code representation ŷₜ. In some implementations, the auto-regressive model may be used as the entropy coding model. However, the coding speed of the auto-regressive model is relatively slow. To accelerate the entropy coding, in some implementations, group-based entropy coding is proposed. Specifically, the quantized code representation ŷₜ includes elements organized along the channel dimension and the spatial dimensions. The elements of the quantized code representation may be partitioned into a plurality of channel element groups along the channel dimension, and each channel element group in the plurality of channel element groups may be further partitioned into a plurality of spatial element groups that are corresponding to a plurality of spatial positions, respectively. As shown schematically in FIG. 6, ŷₜ is partitioned along the channel dimension as four channel element groups 612, including

$${\hat{y}}_{t}^{0} , {\hat{y}}_{t}^{1} , {\hat{y}}_{t}^{2} , and {\hat{y}}_{t}^{3} ,$$

to perform quadtree partition-based entropy coding. Of course, it may be understood that it can also be partitioned into any other appropriate number of channel element groups.

Each channel element group is further partitioned into a plurality of spatial element groups corresponding to a plurality of spatial positions, and the plurality of spatial element groups are overlapped with each other in the frame space. For example, each channel element group may be partitioned into 2×2 spatial areas, each spatial area having a corresponding spatial index (for example, 0, 1, 2, 3), and thus the corresponding partitioned spatial element groups may be obtained. By partitioning the quantized code representation, an entropy coding operation may be partitioned into a plurality of entropy coding operations, to obtain entropy coding results 613, 615, 617, and 619 corresponding to respective channel element groups. After the entropy coding is completed, a plurality of channel element groups are concatenated by the concatenator 620, to complete the channel merging to obtain the quantized code representation ŷₜ.

In each entropy coding operation, a plurality of spatial element groups corresponding to the plurality of spatial positions in the plurality of channel element groups are entropy coded, and combinations of the plurality of spatial element groups entropy-coded in the plurality of entropy coding operations are different.

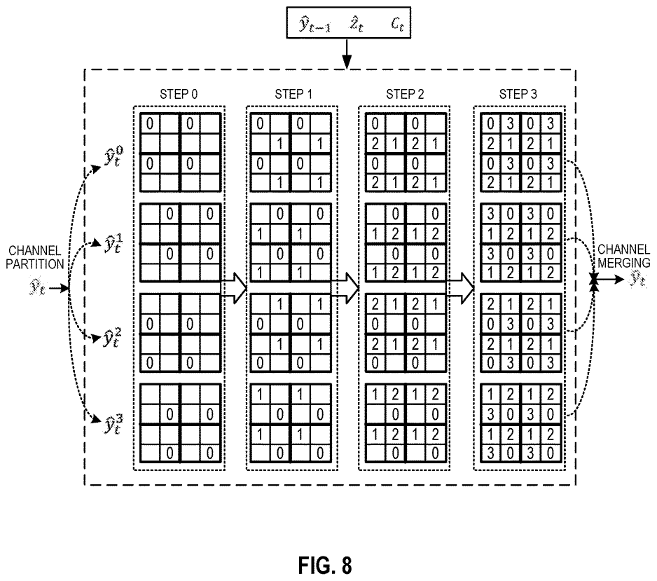

FIG. 8 illustrates an example flow of group-based entropy coding operations in accordance with some implementations of the subject matter described herein. For the purpose of illustration, in the example of FIG. 8, it is assumed that ŷₜ is partitioned into 4 channel element groups along the channel dimension, and each channel element group is partitioned into 2×2 spatial element groups along the spatial dimensions. It would be appreciated that the partitioning based on any other numbers is also feasible and may be implemented through similar operations.

The entropy coding of ŷₜ includes four entropy coding operations. In Step 0, for a first channel element group

$${\hat{y}}_{t}^{0} ,$$

the spatial element group corresponding to Spatial Position 0 is entropy coded; for a second channel element group

$${\hat{y}}_{t}^{1} ,$$

the spatial element group corresponding to Spatial Position 1 is entropy coded; for the third channel element group

$${\hat{y}}_{t}^{2} ,$$

the spatial element group

$${\hat{y}}_{t}^{3} ,$$

the spatial element group corresponding to Spatial Position 3 is entropy coded. In this way, different spatial positions can be explored in a single entropy coding operation. In Step 1, for the first channel element group

$${\hat{y}}_{t}^{0} ,$$

the spatial element group corresponding to another spatial position, such as Spatial Position 1, is entropy coded; for the second channel element group

$${\hat{y}}_{t}^{1} ,$$

the spatial element group corresponding to another spatial position, such as Spatial Position 2, is entropy coded; for the third channel element group

$${\hat{y}}_{t}^{2} ,$$

the spatial element group corresponding to another spatial position, such as Spatial Position 3, is entropy coded; for the fourth channel element group

$${\hat{y}}_{t}^{3} ,$$

the spatial element group corresponding to another spatial position, such as Spatial Position 0, is entropy coded. Entropy coding in Step 2 and Step 3 is performed similarly. Thus, for each spatial position, there is always one channel group coded in each entropy coding operation.

In some implementations, the entropy coding operations may further be based on the quantized code representation ŷₜ₋₁ for the reference frame xₜ₋₁, the hyper prior information \hat{z}ₜ and/or the context information Cₜ for the target frame xₜ. In some implementations, for a given entropy coding operation, it may be performed based on an entropy coding result of a plurality of spatial element groups from a preceding entropy coding operation of the given entropy coding operation. For example, after completing the entropy coding operation in Step 0, in subsequent Steps 1, 2, and 3, the coding results for all the spatial positions in the previous steps may be utilized for the entropy coding of the current step, for example, for predicting PMF of a coding position in the current step, and different spatial positions are coded for different groups in each step.

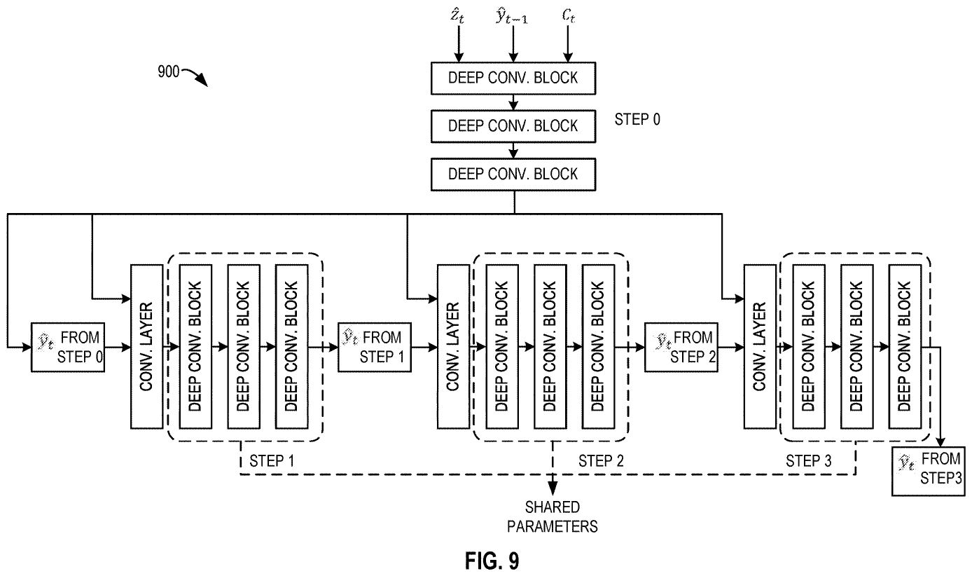

FIG. 9 illustrates a schematic block diagram of an example model implementation of an entropy coding network 900 in accordance with some implementations of the subject matter described herein. In the example of FIG. 9, the entropy coding operation of each step may be implemented based on one or more deep convolution blocks. In Step 0, the quantized code representation ŷₜ₋₁ for the reference frame xₜ₋₁, the hyper prior information \hat{z}ₜ, and/or the context information Cₜ for the target frame xₜ are used as input to extract the entropy coding information for ŷₜ. The encoding result from Step 0 is also passed to the next Step 1 for further implementing the entropy coding of the element group in the current step, and so on. In Steps 1, 2 and 3, a convolution layer may be included to process the input from the previous step, which is followed by one or more deep convolution blocks. In some implementations, to reduce the model parameters, the deep convolution blocks used in Steps 1, 2, and 3 may share their parameters.

Group-based entropy coding may be implemented via parallel-efficient computing, which can reduce the coding time cost. Specifically, in some implementations, the plurality of spatial element groups in each entropy coding operation may be processed in parallel to reduce the computational cost. In some implementations, to further reduce the computational overhead and improve the computational efficiency, the depth-wise separable convolution may be further adopted in the model design, and the unequal channel numbers may be set to the features of different resolutions. Through the group-based entropy coding, more neighborhood information is utilized in entropy coding. For example, in the above example, the information of 0, 4, 4, and 8 adjacent positions is used in the four steps, respectively. In addition, such entropy coding is very efficient because all the spatial positions may be coded in parallel in each step. In addition, the group-based entropy coding may also achieve cross-group correlation. For example, in Step 3, for one specific spatial position of a channel group, other channels at the same position are already coded from other channel groups in the previous steps, and the coding result may be used as context information to perform entropy coding in the current step. This helps to further squeeze the redundancy of video coding. Overall, the group-based entropy coding has benefits from finer-grained and diverse context information, which fully mines the correlation from both spatial and channel dimensions of the video frames.

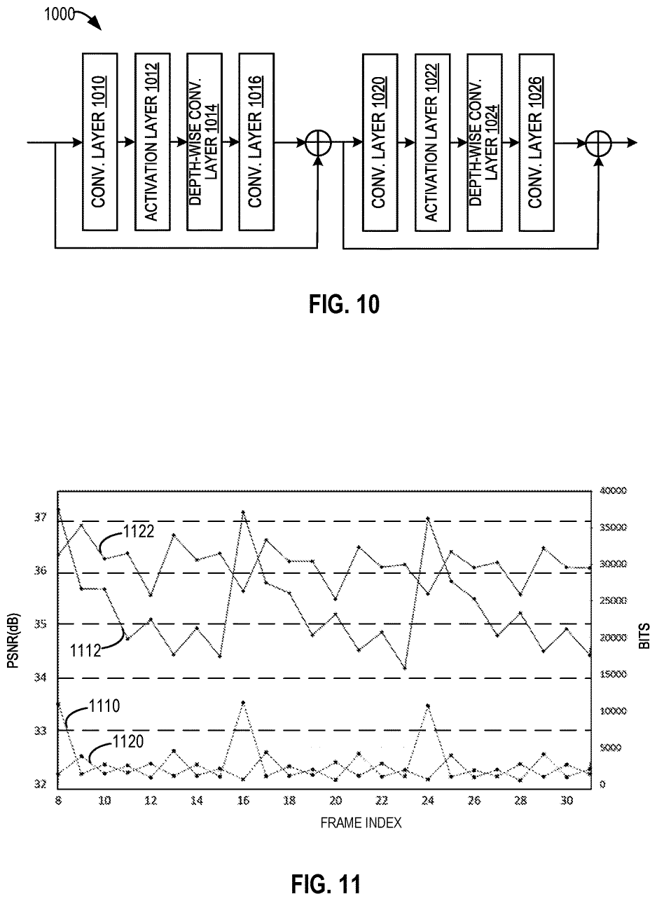

In some implementations, to further reduce the computational overhead, the depth convolution blocks in the entropy coding network 900 may include the depth-wise separable convolution. FIG. 10 illustrates a schematic block diagram of an example model implementation of a deep convolution block 1000 in the entropy coding network 900 in accordance with some implementations of the subject matter described herein. The deep convolution block 1000 may be used to implement one or more deep convolution blocks in the entropy coding network 900. As shown in FIG. 10, the depth convolution block 1000 includes separable convolution part, a first convolution part including a convolution layer 1010, an activation layer 1012 (for example, based on the leaky ReLU function or other appropriate activation function), a depth-wise convolution layer 1014, and a convolution layer 1016. The output of the first convolution part and its input are added and provided to a second convolution part which has the similar structure to the first convolution part. For example, the second convolution part includes a convolution layer 1020, an activation layer 1022 (for example, based on the leaky ReLU function or other appropriate activation function), a depth-wise convolution layer 1024, and a convolution layer 1026. Although FIG. 10 illustrates only two convolution parts, more or fewer convolution parts may be configured if required.

It would be appreciated that FIG. 9 and FIG. 10 only show the example model structures of the entropy coding network and its components. In practical applications, other model structures may be configured for the entropy coding network and its components if required.

### Example Implementations of Model Training

Traditional codec adopts a hierarchical quality structure of frames, in which a plurality of frames are assigned into different layers and use different quantization parameters (QPs). It has been proved in traditional codec that the hierarchical quality structure can achieve scalable video coding and improve the coding performance. On one hand, the hierarchical quality structure is periodically improving the quality of coded frames, which can alleviate the error propagation. During the inter-frame prediction, the high-quality reference frames enable the codec to find more accurate motion information during motion estimation. Meanwhile, the motion compensated prediction is also high-quality, leading to reduced prediction error. On the other hand, in the coding process, multiple reference frames may be selected and weighted, and the prediction combinations from the adjacent reference frame and long-range high-quality reference frame are more diverse. Inspired by the benefits brought by traditional codec, it is expected that the hierarchical quality structure of frames can also be introduced into NVC. One straightforward solution is following the rules of the traditional codec and directly assigning hierarchical QPs in NVC. However, not like traditional codec that use well-predefined rules to perform motion estimation and motion compensation (MEMC), models are used in NVC and MEMC is implicitly implemented in feature domain. For NVC, the practical advantage is that it is automatic learned to achieve better performance, but it has worse robustness and poor generalization ability for out-of-distribution quality patterns. Thus, if the hierarchical QPs are directly provided to NVC, such hierarchical quality patterns cannot be well adapted to all videos, and the MEMC may achieve sub-optimal performance.

Therefore, in some implementations, in the training of the neural video codec system 200, the respective models in the system 200 may be further guided to learn the hierarchical quality patterns across multiple frames. Based on the guidance during the training, it can implicitly learn long-term and high-quality context information that is very useful for the reconstruction of the subsequent frames during the feature transfer. This can further help to take advantage of the long-range temporal correlation in the video and effectively alleviate the quality degradation problem in NVC.

Specifically, for a plurality of sample frames in a sample video used for training the neural video codec system 200, each sample frame is assigned with a weight wₜ. The weight of at least one sample frame is higher than that of other sample frames. In particular, in some implementations, the values of the weights wₜ for the plurality of sample frames follows a hierarchical structure. The weights with the hierarchical structure may be periodically assigned in the sample video. For example, a set of sample frames in the sample video may follow the hierarchical structure, and a next set of sample frames may further follow the hierarchical structure, and so on.

In the training of the neural video codec system 200, a training objective is usually based on the errors between the sample frames and the reconstructed sample frames output by the neural video codec system 200, such as a rate distortion (RD) between the frames. Based on the weights with the hierarchical structure, for each sample frame, the assigned weight wₜ may be used to weight the error corresponding to the sample frame. The training objective is determined based on the weighted errors. The training objective may be represented as a loss function, and an example of which is as follows:

$${L}_{a l l} = \frac{1}{T} {\sum }_{t}^{T} ( {w}_{t} \cdot λ \cdot dist ( {x}_{t} - {\hat{x}}_{t} ) + {r}_{t} ) \qquad ( 1 )$$

where dist( ) represents the rate distortion function between a sample frame xₜ and the reconstructed sample frame \hat{x}ₜ, the weight wₜ represents a weight assigned to the sample frame xₜ, \hat{r}ₜ represents the bit cost of the sample frame xₜ, λ represents the global weight, and T represents the number of sample frames. The training of the neural video codec system 200 is to iteratively optimize the model parameters, so that the value of the loss function is iteratively reduced until the value of the loss function is minimized or reaches a predetermined target.

By weighting with the weights having a hierarchical structure, the errors in the training objective also has a hierarchical structure, which can guide the neural video codec system 200 to learn to control the respective frames in the video to have the hierarchical structure. In this way, the neural video codec system 200 can periodically generate high-quality reconstructed frames \hat{x}ₜ and feature information Fₜ containing rich details. These high-quality reconstructed frames and feature information Fₜ are helpful for improving the MEMC effectiveness and then alleviate the error propagation problem in NVC. In addition, via the cascaded training across multiple frames, the feature propagation chain may be formed. The high-quality contexts which are important for the reconstruction of the following frames may be automatically learned and kept in long range. Thus, for the encoding of xₜ, Fₜ₋₁ not only contains the short-term context extracted from xₜ₋₁, but also provides long-term and continuously-updated high-quality contexts extracted from many previous frames. Such diverse Fₜ₋₁ helps further exploit the temporal correlation across many frames and then boost the compression ratio.

FIG. 11 illustrates a comparison between the hierarchical quality structure of frames in accordance with some implantations of the subject matter described herein and a hierarchical quality structure of a traditional codec. As shown in FIG. 11, the curve 1110 shows the bit change of respective frames coded by the traditional codec, and the curve 1120 shows the bit change of respective frame encoded by the neural codec according to some implementations of the subject matter described herein. The curve 1112 illustrates the signal-to-noise ratios (PSNRs) of respective frame coded by the traditional codec, and the curve 1122 illustrates the PSNRs of respective frame coded by the neural codec according to some implementations of the subject matter described herein. It can be seen that, compared with the traditional codec, video coding according to the implementations of the subject matter described herein can achieve better average quality while with smaller bit cost.

Some examples of the model training process are given above. In other implementations, the models in the neural video codec may be trained in any other suitable way according to the practical applications. The implementations of the subject matter described herein are not limited in this regard.

### Example Process

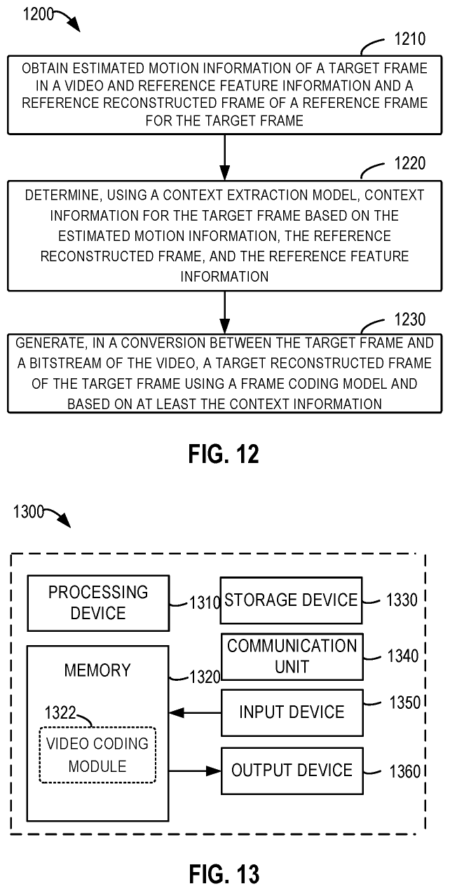

FIG. 12 illustrates a flowchart of a process 1200 for video processing in accordance with some implementations of the subject matter described herein. The process 1200 may be implemented at the neural video codec system 200 of FIG. 2.

At block 1210, the neural video codec system 200 obtains estimated motion information of a target frame in a video and reference feature information and a reference reconstructed frame of a reference frame for the target frame.

At block 1220, the neural video codec system 200 determines, using a context extraction model, context information for the target frame based on the estimated motion information, the reference reconstructed frame, and the reference feature information.

At block 1230, the neural video codec system 200 generates, in a conversion between the target frame and a bitstream of the video, a target reconstructed frame of the target frame using a frame coding model and based on at least the context information.

In some implementations, the reference feature information comprises a plurality of reference feature maps. In some implementations, determining the context information comprises: partitioning the plurality of reference feature maps into a first number of feature map groups; for each feature map group of the first number of feature map groups, determining a second number of motion offsets from the reference frame to the target frame based on the estimated motion information, the reference reconstructed frame, and the feature map group, the second number being greater than one, and performing respective motion alignments on the feature map group based on the second number of motion offsets, to obtain the second number of aligned feature map groups; and determining the context information based on the aligned feature map groups determined for the first number of feature map groups.

In some implementations, determining the context information based on the aligned feature map groups determined for the first number of feature map groups comprises: reordering the aligned feature map groups determined for the first number of feature map groups; merging the reordered aligned feature map groups, to obtain the first number of merged feature map groups, wherein each merged feature map group is merged from the second number of aligned feature maps selected from the reordered aligned feature map groups; and determining the context information based on the first number of merged feature map groups. In some implementations, partitioning the plurality of reference feature maps into the first number of feature map groups comprises: partitioning the plurality of reference feature maps into the first number of feature map groups comprises along a channel dimension.

In some implementations, generating the target reconstructed frame comprises: determining a quantized code representation for the target frame, the quantized code representation comprising elements organized along a channel dimension and spatial dimensions; partitioning the elements of the quantized code representation into a plurality of channel element groups along the channel dimension; partitioning each channel element group of the plurality of channel element groups into a plurality of spatial element groups corresponding to a plurality of spatial positions; and performing a plurality of entropy coding operations, wherein in each entropy coding operation, a plurality of spatial element groups corresponding to the plurality of spatial positions in the plurality of channel element groups are entropy-coded, and combinations of the plurality of spatial element groups that are entropy-coded in the plurality of entropy coding operations are different.

In some implementations, performing the plurality of entropy coding operations comprises: for a given entropy coding operation of the plurality of entropy coding operations, performing the given entropy coding operation based on at least an entropy coding result of a plurality of spatial element groups from a preceding entropy coding operation of the given entropy coding operation.

In some implementations, the context extraction model and the frame coding model are trained using a plurality of sample frames in a sample video, the plurality of sample frames being assigned with a plurality of weights, and at least one weight being higher than other weights among the plurality of weights. In some implementations, a training objective for training the context extraction model and the frame coding model is determined as follows: determining a plurality of errors between the plurality of sample frames and a plurality of reconstructed sample frames output using the context extraction model and the frame coding model; and weighting the plurality of errors with the plurality of assigned weights.

In some implementations, values of the plurality of weights follow a hierarchical structure. In some implementations, the conversion comprises: encoding the target frame as at least a part of the bitstream, or decoding the target frame from the bitstream.

In some implementations, the process 1200 further comprises: generating, in the conversion between the target frame and the bitstream of the video, target feature information of the target frame using the frame coding model and based on at least the context information.

### Example Device

FIG. 13 illustrates a schematic block diagram of an electronic device in which various implementations of the subject matter described herein can be implemented. It would be appreciated that the electronic device 1300 as shown in FIG. 13 is merely provided as an example, without suggesting any limitation to the functionalities and scope of implementations of the subject matter described herein. One or more electronic devices 1300 may, for example, be used to implement the neural video codec system 200 of FIG. 2.

As shown in FIG. 13, the electronic device 1300 is in form of a general-purpose computing device. Components of the electronic device 1300 may include, but are not limited to, one or more processors or processing devices 1310, a memory 1320, a storage device 1330, one or more communication units 1340, one or more input devices 1350, and one or more output devices 1360.

In some implementations, the electronic device 1300 may be implemented as a device with computing capability, such as a computing device, a computing system, a server, a mainframe and the like.

The processing device 1310 can be a physical or virtual processor and can execute various processing based on the programs stored in the memory 1320. In a multi-processor system, a plurality of processing units execute computer-executable instructions in parallel so as to enhance parallel processing capability of the electronic device 1300. The processing device 1310 may include a central processing unit (CPU), a graphics processing unit (GPU), a microprocessor, a controller, and/or a microcontroller.

The electronic device 1300 usually includes various computer storage medium. Such medium may be any available medium accessible by the electronic device 1300, including but not limited to, volatile and non-volatile medium, or detachable and non-detachable medium. The memory 1320 may be a volatile memory (for example, a register, cache, Random Access Memory (RAM)), non-volatile memory (for example, a Read-Only Memory (ROM), Electrically Erasable Programmable Read-Only Memory (EEPROM), a flash memory), or any combination thereof. The storage device 1330 may be any detachable or non-detachable medium and may include computer-readable medium such as a memory, a flash memory drive, a magnetic disk or any other medium that can be used for storing information and/or data and are accessible by the electronic device 1300.

The electronic device 1300 may further include additional detachable/non-detachable, volatile/non-volatile memory medium. Although not shown in FIG. 13, there may be provided a disk drive for reading from or writing into a detachable and non-volatile disk, and an optical disk drive for reading from and writing into a detachable non-volatile optical disc. In such cases, each drive may be connected to a bus (not shown) via one or more data medium interfaces.

The communication unit 1340 implements communication with another computing device via the communication medium. In addition, the functionalities of components in the electronic device 1300 may be implemented by a single computing cluster or a plurality of computing machines that can communicate with each other via communication connections. Thus, the electronic device 1300 may operate in a networked environment using a logic connection with one or more other servers, network personal computers (PCs), or further general network nodes.

The input device 1350 may include one or more of a variety of input devices, such as a mouse, keyboard, data import device and the like. The output device 1360 may be one or more output devices, such as a display, data export device and the like. By means of the communication unit 1340, the electronic device 1300 may further communicate with one or more external devices (not shown) such as storage devices and display devices, one or more devices that enable the user to interact with the electronic device 1300, or any devices (such as a network card, a modem and the like) that enable the electronic device 1300 to communicate with one or more other computing devices, if required. Such communication may be performed via input/output (I/O) interfaces (not shown).

In some implementations, as an alternative of being integrated on a single device, some or all components of the electronic device 1300 may also be arranged in the form of cloud computing architecture. In the cloud computing architecture, the components may be provided remotely and work together to implement the functionalities described in the subject matter described herein. In some implementations, cloud computing provides computing, software, data access and storage service, which will not require end users to be aware of the physical locations or configurations of the systems or hardware provisioning these services. In various implementations, the cloud computing provides the services via a wide area network (such as Internet) using proper protocols. For example, a cloud computing provider provides applications over the wide area network, which may be accessed through a web browser or any other computing components. The software or components of the cloud computing architecture and corresponding data may be stored in a server at a remote position.

The computing resources in the cloud computing environment may be aggregated or distributed at locations of remote data centers. Cloud computing infrastructure may provide the services through a shared data center, though they behave as a single access point for the users. Therefore, the cloud computing infrastructure may be utilized to provide the components and functionalities described herein from a service provider at remote locations. Alternatively, they may be provided from a conventional server or may be installed directly or otherwise on a client device.

The electronic device 1300 may be used to implement resource management in accordance with various implementations of the subject matter described herein. The memory 1320 may include one or more modules having one or more program instructions. These modules may be accessed and run by the processing unit 1310 to perform functions of various implementations described herein. For example, the memory 1320 may include a video coding module 1322 for performing video coding using a neural video codec. As shown in FIG. 13, the electronic device 1300 may obtain a video to be encoded or a bitstream to be decoded through the input device 1350 and provide the encoded bitstream or the decoded video through the output device 1360. In some implementations, the electronic device 1300 may further receive the input from other devices (not shown) via the communication unit 1340.

Some example implementations of the subject matter described herein are listed below. In an aspect, the subject matter described herein provides a computer-implemented method. The method comprises: obtaining estimated motion information of a target frame in a video and reference feature information and a reference reconstructed frame of a reference frame for the target frame; determining, using a context extraction model, context information for the target frame based on the estimated motion information, the reference reconstructed frame, and the reference feature information; and generating, in a conversion between the target frame and a bitstream of the video, a target reconstructed frame of the target frame using a frame coding model and based on at least the context information.

In some implementations, the reference feature information comprises a plurality of reference feature maps. In some implementations, determining the context information comprises: partitioning the plurality of reference feature maps into a first number of feature map groups; for each feature map group of the first number of feature map groups, determining a second number of motion offsets from the reference frame to the target frame based on the estimated motion information, the reference reconstructed frame, and the feature map group, the second number being greater than one, and performing respective motion alignments on the feature map group based on the second number of motion offsets, to obtain the second number of aligned feature map groups; and determining the context information based on the aligned feature map groups determined for the first number of feature map groups.

In some implementations, determining the context information based on the aligned feature map groups determined for the first number of feature map groups comprises: reordering the aligned feature map groups determined for the first number of feature map groups; merging the reordered aligned feature map groups, to obtain the first number of merged feature map groups, wherein each merged feature map group is merged from the second number of aligned feature maps selected from the reordered aligned feature map groups; and determining the context information based on the first number of merged feature map groups. In some implementations, partitioning the plurality of reference feature maps into the first number of feature map groups comprises: partitioning the plurality of reference feature maps into the first number of feature map groups comprises along a channel dimension.

In some implementations, generating the target reconstructed frame comprises: determining a quantized code representation for the target frame, the quantized code representation comprising elements organized along a channel dimension and spatial dimensions; partitioning the elements of the quantized code representation into a plurality of channel element groups along the channel dimension; partitioning each channel element group of the plurality of channel element groups into a plurality of spatial element groups corresponding to a plurality of spatial positions; and performing a plurality of entropy coding operations, wherein in each entropy coding operation, a plurality of spatial element groups corresponding to the plurality of spatial positions in the plurality of channel element groups are entropy-coded, and combinations of the plurality of spatial element groups that are entropy-coded in the plurality of entropy coding operations are different.

In some implementations, performing the plurality of entropy coding operations comprises: for a given entropy coding operation of the plurality of entropy coding operations, performing the given entropy coding operation based on at least an entropy coding result of a plurality of spatial element groups from a preceding entropy coding operation of the given entropy coding operation.

In some implementations, the context extraction model and the frame coding model are trained using a plurality of sample frames in a sample video, the plurality of sample frames being assigned with a plurality of weights, and at least one weight being higher than other weights among the plurality of weights. In some implementations, a training objective for training the context extraction model and the frame coding model is determined as follows: determining a plurality of errors between the plurality of sample frames and a plurality of reconstructed sample frames output using the context extraction model and the frame coding model; and weighting the plurality of errors with the plurality of assigned weights.

In some implementations, values of the plurality of weights follow a hierarchical structure. In some implementations, the conversion comprises: encoding the target frame as at least a part of the bitstream, or decoding the target frame from the bitstream.

In some implementations, the method further comprises: generating, in the conversion between the target frame and the bitstream of the video, target feature information of the target frame using the frame coding model and based on at least the context information.

In another aspect, the subject matter described herein provides an electronic device. The electronic device comprises a processor; and a memory coupled to the processor and comprising instructions stored thereon which, when executed by the processor, cause the device to perform acts comprising: obtaining estimated motion information of a target frame in a video and reference feature information and a reference reconstructed frame of a reference frame for the target frame; determining, using a context extraction model, context information for the target frame based on the estimated motion information, the reference reconstructed frame, and the reference feature information; and generating, in a conversion between the target frame and a bitstream of the video, a target reconstructed frame of the target frame using a frame coding model and based on at least the context information.

In some implementations, the reference feature information comprises a plurality of reference feature maps. In some implementations, determining the context information comprises: partitioning the plurality of reference feature maps into a first number of feature map groups; for each feature map group of the first number of feature map groups, determining a second number of motion offsets from the reference frame to the target frame based on the estimated motion information, the reference reconstructed frame, and the feature map group, the second number being greater than one, and performing respective motion alignments on the feature map group based on the second number of motion offsets, to obtain the second number of aligned feature map groups; and determining the context information based on the aligned feature map groups determined for the first number of feature map groups.

In some implementations, determining the context information based on the aligned feature map groups determined for the first number of feature map groups comprises: reordering the aligned feature map groups determined for the first number of feature map groups; merging the reordered aligned feature map groups, to obtain the first number of merged feature map groups, wherein each merged feature map group is merged from the second number of aligned feature maps selected from the reordered aligned feature map groups; and determining the context information based on the first number of merged feature map groups.

In some implementations, partitioning the plurality of reference feature maps into the first number of feature map groups comprises: partitioning the plurality of reference feature maps into the first number of feature map groups comprises along a channel dimension.

In some implementations, generating the target reconstructed frame comprises: determining a quantized code representation for the target frame, the quantized code representation comprising elements organized along a channel dimension and spatial dimensions; partitioning the elements of the quantized code representation into a plurality of channel element groups along the channel dimension; partitioning each channel element group of the plurality of channel element groups into a plurality of spatial element groups corresponding to a plurality of spatial positions; and performing a plurality of entropy coding operations, wherein in each entropy coding operation, a plurality of spatial element groups corresponding to the plurality of spatial positions in the plurality of channel element groups are entropy-coded, and combinations of the plurality of spatial element groups that are entropy-coded in the plurality of entropy coding operations are different.

In some implementations, performing the plurality of entropy coding operations comprises: for a given entropy coding operation of the plurality of entropy coding operations, performing the given entropy coding operation based on at least an entropy coding result of a plurality of spatial element groups from a preceding entropy coding operation of the given entropy coding operation.

In some implementations, the context extraction model and the frame coding model are trained using a plurality of sample frames in a sample video, the plurality of sample frames being assigned with a plurality of weights, and at least one weight being higher than other weights among the plurality of weights. In some implementations, a training objective for training the context extraction model and the frame coding model is determined as follows: determining a plurality of errors between the plurality of sample frames and a plurality of reconstructed sample frames output using the context extraction model and the frame coding model; and weighting the plurality of errors with the plurality of assigned weights.

In some implementations, values of the plurality of weights follow a hierarchical structure. In some implementations, the conversion comprises: encoding the target frame as at least a part of the bitstream, or decoding the target frame from the bitstream.

In some implementations, the acts further comprise: generating, in the conversion between the target frame and the bitstream of the video, target feature information of the target frame using the frame coding model and based on at least the context information.

In yet another aspect, the subject matter described herein provides a computer program product that is tangibly stored in a computer storage medium and comprises computer executable instructions that, when executed by a device, cause the device to perform acts comprising: obtaining estimated motion information of a target frame in a video and reference feature information and a reference reconstructed frame of a reference frame for the target frame; determining, using a context extraction model, context information for the target frame based on the estimated motion information, the reference reconstructed frame, and the reference feature information; and generating, in a conversion between the target frame and a bitstream of the video, a target reconstructed frame of the target frame using a frame coding model and based on at least the context information.

In yet another aspect, the subject matter described herein provides a computer-readable medium having computer executable instructions stored thereon that, when executed by a device, cause the device to perform one or more example implementations of the method in the above aspect.

The functionalities described herein can be performed, at least in part, by one or more hardware logic components. As an example, and without limitation, illustrative types of hardware logic components that can be used include field-programmable gate arrays (FPGAs), Application-specific Integrated Circuits (ASICs), application-specific standard products (ASSPs), system-on-a-chip systems (SOCs), complex programmable logic devices (CPLDs), and the like.

Program code for carrying out the methods of the subject matter described herein may be written in any combination of one or more programming languages. The program code may be provided to a processor or controller of a general-purpose computer, special purpose computer, or other programmable data processing flowchart such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of the subject matter described herein, a machine-readable medium may be any tangible medium that may contain or store a program for use by or in connection with an instruction execution system, flowchart, or device. The machine-readable medium may be a machine-readable signal medium or a machine-readable storage medium. A machine-readable medium may include but is not limited to an electronic, magnetic, optical, electromagnetic, infrared, or semiconductor system, flowchart, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although the operations are depicted in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in various implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1. A computer-implemented method comprising:
obtaining estimated motion information of a target frame in a video and reference feature information and a reference reconstructed frame of a reference frame for the target frame;
determining, using a context extraction model, context information for the target frame based on the estimated motion information, the reference reconstructed frame, and the reference feature information; and
generating, in a conversion between the target frame and a bitstream of the video, a target reconstructed frame of the target frame using a frame coding model and based on at least the context information.

2. The method of claim 1, wherein the reference feature information comprises a plurality of reference feature maps, and wherein determining the context information comprises:
partitioning the plurality of reference feature maps into a first number of feature map groups;
for each feature map group of the first number of feature map groups,
determining a second number of motion offsets from the reference frame to the target frame based on the estimated motion information, the reference reconstructed frame, and the feature map group, the second number being greater than one, and
performing respective motion alignments on the feature map group based on the second number of motion offsets, to obtain the second number of aligned feature map groups; and
determining the context information based on the aligned feature map groups determined for the first number of feature map groups.

3. The method of claim 2, wherein determining the context information based on the aligned feature map groups determined for the first number of feature map groups comprises:
reordering the aligned feature map groups determined for the first number of feature map groups;
merging the reordered aligned feature map groups, to obtain the first number of merged feature map groups, wherein each merged feature map group is merged from the second number of aligned feature maps selected from the reordered aligned feature map groups; and
determining the context information based on the first number of merged feature map groups.

4. The method of claim 2, wherein partitioning the plurality of reference feature maps into the first number of feature map groups comprises:
partitioning the plurality of reference feature maps into the first number of feature map groups comprises along a channel dimension.

5. The method of claim 1, wherein generating the target reconstructed frame comprises:
determining a quantized code representation for the target frame, the quantized code representation comprising elements organized along a channel dimension and spatial dimensions;
partitioning the elements of the quantized code representation into a plurality of channel element groups along the channel dimension;
partitioning each channel element group of the plurality of channel element groups into a plurality of spatial element groups corresponding to a plurality of spatial positions; and
performing a plurality of entropy coding operations, wherein in each entropy coding operation, a plurality of spatial element groups corresponding to the plurality of spatial positions in the plurality of channel element groups are entropy-coded, and combinations of the plurality of spatial element groups that are entropy-coded in the plurality of entropy coding operations are different.

6. The method of claim 5, wherein performing the plurality of entropy coding operations comprises: for a given entropy coding operation of the plurality of entropy coding operations,
performing the given entropy coding operation based on at least an entropy coding result of a plurality of spatial element groups from a preceding entropy coding operation of the given entropy coding operation.

7. The method of claim 1, wherein the context extraction model and the frame coding model are trained using a plurality of sample frames in a sample video, the plurality of sample frames being assigned with a plurality of weights, and at least one weight being higher than other weights among the plurality of weights, and
wherein a training objective for training the context extraction model and the frame coding model is determined as follows:
determining a plurality of errors between the plurality of sample frames and a plurality of reconstructed sample frames output using the context extraction model and the frame coding model; and
weighting the plurality of errors with the plurality of assigned weights.

8. The method of claim 7, wherein values of the plurality of weights follow a hierarchical structure.

9. The method of claim 1, wherein the conversion comprises:
encoding the target frame as at least a part of the bitstream, or
decoding the target frame from the bitstream.

10. The method of claim 1, further comprising:
generating, in the conversion between the target frame and the bitstream of the video, target feature information of the target frame using the frame coding model and based on at least the context information.

11. An electronic device comprising:
a processor; and
a memory coupled to the processor and comprising instructions stored thereon which, when executed by the processor, cause the device to perform acts comprising:
obtaining estimated motion information of a target frame in a video and reference feature information and a reference reconstructed frame of a reference frame for the target frame;
determining, using a context extraction model, context information for the target frame based on the estimated motion information, the reference reconstructed frame, and the reference feature information; and
generating, in a conversion between the target frame and a bitstream of the video, a target reconstructed frame of the target frame using a frame coding model and based on at least the context information.

12. The device of claim 11, wherein the reference feature information comprises a plurality of reference feature maps, and wherein determining the context information comprises:
partitioning the plurality of reference feature maps into a first number of feature map groups;
for each feature map group of the first number of feature map groups,
determining a second number of motion offsets from the reference frame to the target frame based on the estimated motion information, the reference reconstructed frame, and the feature map group, the second number being greater than one, and
performing respective motion alignments on the feature map group based on the second number of motion offsets, to obtain the second number of aligned feature map groups; and
determining the context information based on the aligned feature map groups determined for the first number of feature map groups.

13. The device of claim 12, wherein determining the context information based on the aligned feature map groups determined for the first number of feature map groups comprises:
reordering the aligned feature map groups determined for the first number of feature map groups;
merging the reordered aligned feature map groups, to obtain the first number of merged feature map groups, wherein each merged feature map group is merged from the second number of aligned feature maps selected from the reordered aligned feature map groups; and
determining the context information based on the first number of merged feature map groups.

14. The device of claim 11, wherein generating the target reconstructed frame comprises:
determining a quantized code representation for the target frame, the quantized code representation comprising elements organized along a channel dimension and spatial dimensions;
partitioning the elements of the quantized code representation into a plurality of channel element groups along the channel dimension;
partitioning each channel element group of the plurality of channel element groups into a plurality of spatial element groups corresponding to a plurality of spatial positions; and
performing a plurality of entropy coding operations, wherein in each entropy coding operation, a plurality of spatial element groups corresponding to the plurality of spatial positions in the plurality of channel element groups are entropy-coded, and combinations of the plurality of spatial element groups that are entropy-coded in the plurality of entropy coding operations are different.

15. A computer program product being tangibly stored in a computer storage medium and comprising computer executable instructions that, when executed by a device, cause the device to perform acts comprising:
obtaining estimated motion information of a target frame in a video and reference feature information and a reference reconstructed frame of a reference frame for the target frame;
determining, using a context extraction model, context information for the target frame based on the estimated motion information, the reference reconstructed frame, and the reference feature information; and
generating, in a conversion between the target frame and a bitstream of the video, a target reconstructed frame of the target frame using a frame coding model and based on at least the context information.

16. The computer program product of claim 15, wherein the reference feature information comprises a plurality of reference feature maps, and wherein determining the context information comprises:
partitioning the plurality of reference feature maps into a first number of feature map groups;
for each feature map group of the first number of feature map groups,
determining a second number of motion offsets from the reference frame to the target frame based on the estimated motion information, the reference reconstructed frame, and the feature map group, the second number being greater than one, and
performing respective motion alignments on the feature map group based on the second number of motion offsets, to obtain the second number of aligned feature map groups; and
determining the context information based on the aligned feature map groups determined for the first number of feature map groups.

17. The computer program product of claim 15, wherein generating the target reconstructed frame comprises:
determining a quantized code representation for the target frame, the quantized code representation comprising elements organized along a channel dimension and spatial dimensions;
partitioning the elements of the quantized code representation into a plurality of channel element groups along the channel dimension;
partitioning each channel element group of the plurality of channel element groups into a plurality of spatial element groups corresponding to a plurality of spatial positions; and
performing a plurality of entropy coding operations, wherein in each entropy coding operation, a plurality of spatial element groups corresponding to the plurality of spatial positions in the plurality of channel element groups are entropy-coded, and combinations of the plurality of spatial element groups that are entropy-coded in the plurality of entropy coding operations are different.

18. The computer program product of claim 15, wherein the context extraction model and the frame coding model are trained using a plurality of sample frames in a sample video, the plurality of sample frames being assigned with a plurality of weights, and at least one weight being higher than other weights among the plurality of weights, and
wherein a training objective for training the context extraction model and the frame coding model is determined as follows:
determining a plurality of errors between the plurality of sample frames and a plurality of reconstructed sample frames output using the context extraction model and the frame coding model; and
weighting the plurality of errors with the plurality of assigned weights.

19. The computer program product of claim 15, wherein the conversion comprises:
encoding the target frame as at least a part of the bitstream, or
decoding the target frame from the bitstream.

20. The computer program product of claim 15, the acts further comprising:
generating, in the conversion between the target frame and the bitstream of the video, target feature information of the target frame using the frame coding model and based on at least the context information.
